(19) United States
(12) Patent Application Publication
(10) Pub. No.: US 2019/0007998 A1
(43) Pub. Date: Jan. 3, 2019

(54) Rare-Earth Doped Semiconductor Infrared Radiation Thick-Film Electronic Paste and Preparation Method Therefor

(71) Applicant: Corehelm Electronic Material Co., Ltd., Dongguan City, Guangdong (CN)

(72) Inventors: Guanxian SU, Dongguan City, Guangdong (CN); Jian Liu, Dongguan City, Guangdong (CN)

(73) Assignee: Corehelm Electronic Material Co., Ltd., Dongguan City, Guangdong (CN)

(21) Appl. No.: 16/065,389

(22) PCT Filed: Jul. 18, 2016
(86) PCT No.: PCT/CN2016/090289

§ 371 Date: Jun. 22, 2018

(30) Foreign Application Priority Data
Dec. 23, 2015 (CN) 201510978180.5

(51) Int. Cl. H05B 3/14

(52) U.S. Cl. CPC H05B 3/14; H05B 2203/017; H05B 2203/013; H05B 2203/002

(57) ABSTRACT

A rare-earth doped semiconductor infrared radiation thick-film electronic paste and a preparation method therefor. The electronic paste comprises, in parts by weight, 10%-90% of organic vehicle and 10%-90% of functional phase. The organic vehicle comprises, in parts by weight, 50%-95% of organic solvent, 1%-40% of thickener, and 0%-5% of organic aid. The functional phase comprises, in parts by weight, 40%-95% of rare-earth doped infrared radiation semiconductor material, 5%-60% of conductor material, and 0%-20% of functional additive. The electronic paste features a wide range of selectable base materials, a wide heating temperature range, high heating efficiency, and a heating body of low temperature, and can implement bidirectional conversion of heat to electricity and electricity to heat. The preparation method comprises: a. mixing a thickener, an organic aid, and an organic solvent to prepare an organic vehicle; b. mixing the organic vehicle and a functional phase, and grinding the mixture to prepare an electronic paste; and c. printing the electronic paste onto a substrate by means of screen printing, and curing or sintering same to form a film.

### TECHNICAL FIELD

The present invention relates to the technical field of electronic materials, in particular to a rare earth doped semiconductor infrared radiation thick-film electronic paste and preparation method thereof.

### BACKGROUND

Electrothermal materials are materials using the heating effect of electric current. Metal-based electrothermal materials mainly include noble metal (Pt), metals having high melting point (W, Mo, Ta, Nb) and alloys thereof, nickel-base alloys and iron-aluminum alloys. The most widely used metal electrothermal materials are mainly nickel-chromium alloys and iron-aluminum alloys. Metal electrothermal materials mainly include silicon carbide, lanthanum chromate, zirconia, and molybdenum disilicide etc. They have the advantages of high temperature resistance, corrosion resistance, oxidation resistance, and high electrothermal conversion efficiency, and are gradually, replacing the metal electrothermal materials. The traditional electric heating sources are generally large in size, low in energy efficiency, and inconvenient in application, and are difficult to meet the requirements for modern industry and living.

A thick film heating technology is gradually promoted in China, however, only conduction and convection can be used as main heat transfer manners, moreover, the products have poor stability, the heat bodies themselves have high temperature, and there are significant limitations in the field of applications and the selection of substrates.

The heat transfer form used by infrared is radiative heat transfer, wherein the energy is transferred by electromagnetic waves. When a object to be heated is irradiated by far infrared, some of the rays are reflected back and some penetrates into the object. When the wavelength of the emitted far-infrared is the same as the absorption wavelength of the object to be heated, the object will absorb the far-infrared. At this time, a “resonance” occurs between the molecules and atoms within the object, resulting in strong vibration, rotation, and the vibration and rotation raise the temperature of the object, achieving the purpose of heating. Infrared radiation refers to the emission and transmission (propagation) of electromagnetic waves having spectra between 0.7 um and 80 um. The emission and transmission are accompanied by significant directed energy propagation. The energy transfer requires no exchange medium and can be transferred even in vacuum. The infrared can be divided into short wave, medium wave and long wave according to the wavelength thereof.

Infrared drying and heating have been accepted at an astonishing rate of development in recent years and have been applied in various fields, mainly because the infrared heating has the following advantages: 1, penetrability, allowing heating simultaneously inside and outside; 2, no need for heat transfer medium, good thermal efficiency; 3, be able to heat locally, saving energy; 4, providing a comfortable working environment; 5, saving the building cost and space for a furnace, simple and easy combination, installation and maintenance; 6, clean heating process, no need for hot air, no secondary pollution; 7, easily controlled temperature, rapid temperature rise, and more security; 8, small thermal inertia, no need for warming machinery, saving labor.

Energy-saving principle of an infrared heating tube: multiple reflections and refractions are generated when the far-infrared pass through the quartz tube, which results in an opacifying effect. It has excellent far-infrared radiation characteristics. A better effect will be achieved if it is coated with gold or semi-coated with white alumina on the back, saving up to 35% of electricity. Performance of the infrared heating tube: the infrared heating tube has the characteristics of no need for external coat, no need for internal filler, stable emissivity, no deformation at high temperature, no harmful radiation, no environmental pollution, strong corrosion resistance, good chemical stability, low thermal inertia, high heat conversion rate, long service life, no fading. The infrared heating tube is a tubular heater which utilizes the principle of infrared. It is characterized by good quality, high thermal efficiency, high power density, rapid temperature rise, power saving, and long service life. It is an energy-saving heating technology which has been. developed rapidly in the 1980s. It has been listed as a key promotion project in China and has achieved gratifying economic benefits. The infrared is widely used in industrial heating or drying, for example the process of surface heating and drying and curing in fields such as automotive, plastic, printing, glass, textiles, food, metal parts, circuit board packaging, film and electronics, etc. By using transparent or translucent quartz glass as a lamp housing, the near-infrared, far-infrared quartz lamps can generate near infrared or far infrared radiation spectra. Infrared is a kind of electromagnetic wave, which transmit at the speed of light and carries high energy. Different types of infrared ray having the same power will have different intensity depending on radiation intensity and wavelength thereof Long-wave infrared (i.e. far-infrared) has the characteristics of rapid temperature rise, uniform heating, low thermal inertia, only 1-3 minutes for the component to reach a constant temperature, up to 60%-75% of electric energy-radiation conversion efficiency, no burst upon hot and cold, energy saving, and long service life. Short-wave infrared (i.e. near-infrared) has the characteristics of 1-3 seconds of warming and cooling time, making the heating process more flexible. The gold coated reflecting layer which is high efficiency and durable in single-tube and double-tube can achieve more than 96% of radiation efficiency, with ultralong service life, generally more than 10,000 hours. It is especially widely used in the drying and curing for high-speed printing equipment. It can quickly heat the surface of an object such as plastic, water and other solvents, and has the characteristics of being quickly absorbed by water film to achieve a drying effect.

The above described advantages of infrared heating make it possible to obtain a high efficiency and high uniformity heating, so that a high-quality product can be obtained. However, infrared heaters have high production costs and are bulky, and difficult to miniaturize.

As an inexhaustible renewable energy source, solar energy has the advantages of clean, non-polluting, huge total radiation power and inexhaustible. It is an important measure for the sustainable development of human society to develop and use the solar energy. Use of solar energy by humans has a very long history, and the solar energy technology is the most mature. The basic manner to use the solar energy is to use photothermal conversion materials to convert solar radiation to thermal energy. In the 1950s, there was a significant technological breakthrough in the field of solar photothermal conversion and utilization. In 1955, Tabor from Israeli proposed the concept of a selective absorption surface and theoretical basis thereof, and successfully developed a practical black-nickel photothermal conversion material. China has done a lot of work in the research and application of traditional photothermal conversion materials. Solar batteries, solar water heaters, and solar photothermal conversion heat storage fibers have been produced by using solar photothermal conversion materials. However, their low photothermal conversion efficiency, and poor persistence on heat storage have become technical problems that are difficult to overcome. The applications of new types of photothermal conversion materials, such as noble metal nanomaterials, carbon nanomaterials, and semiconducting nanomaterials, in photothermal conversion have also been reported.

However, the traditional photothermal conversion materials developed in China suffer from technical defects such as low photothermal conversion efficiency and poor persistence on heat storage.

### SUMMARY OF THE INVENTION

The purpose of the present invention is to provide a rare earth doped semiconductor infrared radiation thick-film electronic paste in view of the defects in the prior art. The rare earth doped semiconductor infrared radiation thick-film electronic paste has a wide range of selectable base materials, a wide heating temperature range covering medium and low to high temperatures, high heating efficiency, and a heating body of low temperature, and can achieve bidirectional conversion of heat to electricity and electricity to heat.

Another purpose of the present invention is to provide a method for preparing a rare earth doped semiconductor infrared radiation thick-film electronic paste, which can effectively prepare a rare earth doped semiconductor infrared radiation thick film electronic paste.

To achieve the above purposes, the present invention is implemented by the following technical solutions.

A rare earth doped semiconductor infrared radiation thick-film electronic paste, including the following materials in parts by weight, specifically:
10%-90% of an organic carrier
10%-90% of a functional phase;
wherein, the organic carrier includes the following materials in parts by weight, specifically:
50%-95% of an organic solvent
1%-40% of a thickener
0%-5% of an organic auxiliary;
the functional phase includes the following materials in parts by weight, specifically:
40%-95% of a rare earth doped infrared radiation semiconductor material
5%-60% of a conductor material
0%-20% of a functional additive.

Wherein the organic solvent is a combination of two or more of terpineol, methyl ether, turpentine, tritolyl phosphate isopropanol, ethyl ether, xylene, butyl carbitol acetate, benzyl alcohol, butyl carbitol, ethanol, dibutyl phthalate, propanol, diethyl phthalate, triphenyl phosphate, ethyl acetate, amyl propionate, dioctyl phthalate, furfuryl alcohol, tributyl citrate, diffusion pump oil, cyclohexanone, tributyl phosphate, ethyl lactate, and ethyl benzoate.

Wherein the thickener is a combination of two or more of ethyl cellulose, cellulose acetate butyrate, acrylic resin, amino resin, polyester resin, phenolic resin, polyimide resin, silicone resin, epoxy resin, and rosin resin.

Wherein the organic auxiliary is a combination of two or more of a leveling agent, an anti-foaming agent, a thixotropic agent, an adhesion promoter, a curing agent, a dispersant, a wetting agent, a toughening agent, an emulsifier, an anti-skinning agent, a delusterant, a light stabilizer, an anti-mould agent, an anti-static agent, an anti-adhesion agent, an anti-cratering agent, a hammer tone auxiliary, a foam suppressor, an anti-gelling agent, an anti-floating agent.

Wherein the rare earth doped infrared radiation semiconductor material is one of rare earth doped TiO2, TiC, SiC, AlN, SnO2, CdO, Fe2O3, Cr2O3, Al2O3, AlCaN, GaN, InAlN, Cu2O, NiO, VO2, Ta2O5, WC, TaC, VC, ZrC, HfC, CdO, MnO2, CoO, Cu2O, CoO, Cr2O3, SnO, Cu2S, SnS, Hg2O, PbO, Ag2O, Ag2O, Cr2O3, MnO, CoO, SnO, NiO, Cu2O, Cu2S, Pr2O3, SnS, Sb2S3, CuI, Bi2Te3, Te, Se, MoO2, Hg2O, V2O5, CrO3, ZnO, WO3, CuO, MoO2, Ag2S, CdS, Nb2O5, BaO, ZnF2, Hg2S, Fe3O4, V2O5, V3O8, Ag2S, Nb2O5, MoO3, CdO, CsS, CdS, CdSe, SnO2, WO3, Cs2Se, BaO, Ta2O5, BaTiO3, PbCrO4, Fe3O4, Hg2S, ZnF2, ZnO, CdCr2Se4, LaFeO3, or a combination of two or more thereof.

Wherein the conductor material is one of a metal conductor material, an inorganic non-metal conductor material and a polymer conductor material, or a combination of two or more thereof. The state of conductor material is one of powder, fiber and solution, or a combination of two or more thereof. The metal conductor material is one of aluminum, copper, chromium, molybdenum, vanadium, zinc, nickel, cobalt, tungsten, manganese, gold, silver, platinum, ruthenium, rhodium, palladium, osmium, iridium and metal alloy, or a combination of two or more thereof. The inorganic non-metal conductor material is one of a carbon material, a conductive glass and a metal oxide, or a combination of two or more thereof. The polymer conductor material is one of polyacetylene, polythiophene, polypyrrole, polyaniline, polyphenylene, polyphenylenevinylene and polydiacetylene, or a combination of two or more thereof.

Wherein the carbon material is one of graphene, electric conductive carbon black, chopped carbon fiber, carbon nanofiber, carbon nanotube, spiral carbon and graphite powder, or a combination of two or more thereof.

Wherein, the rare earth is one of a rare earth elementary substance and a rare earth compound, or a combination of two or more thereof. The rare earth elementary substance is one of scandium, yttrium, lanthanum, cerium, praseodymium, neodymium, promethium, samarium, europium, gadolinium, terbium, dysprosium, holmium, erbium, thulium, ytterbium, lutetium, scandium, or a combination of two or more thereof. The rare earth compound is one of oxides and salts of scandium, yttrium, lanthanum, cerium, praseodymium, neodymium, promethium, samarium, europium, gadolinium, terbium, dysprosium, holmium, erbium, thulium, ytterbium, lutetium, scandium, or a combination of two or more thereof.

Wherein the functional additive is one of an inorganic binder, an electrical performance enhancer, a reinforcing agent, a toughening agent, and a fluxing agent, or a combination of two or more thereof. The inorganic binder is one of a glass powder, an oxide of copper and another compound of copper, or a combination of two or more thereof. The electrical performance enhancer is one of a metal compound, an intermetallic compound and a ceramic powder, or a combination of two or more thereof.

A method for preparing a rare earth doped semiconductor infrared. radiation thick-film electronic paste, including the following process steps, specifically:
a. mixing a thickener, an organic auxiliary and an organic solvent to obtain an organic carrier, wherein the parts by weight of the thickener, the organic auxiliary and the organic solvent are 50-95%, 1-40% and 0-5%, respectively.
b. mixing the organic carrier and a functional phase, and grounding the same to obtain an electronic paste, wherein the parts by weight of the organic carrier and the functional phase are 10-90% and 10-90%, respectively, and the functional phase includes the following materials in parts by weight: 40%-95% of a rare earth doped infrared radiation semiconductor material, 5%-60% of a conductor material, 0%-20% of a functional additive;
c. printing the prepared electronic paste onto a substrate by screen printing, and curing or sintering it to form a film to obtain the rare earth doped semiconductor infrared radiation thick-film.

The present invention has the following beneficial effects: a rare earth doped semiconductor infrared radiation thick-film electronic paste according the present invention includes the following materials in parts by weight: 10%-90% of an organic carrier, 10%-90% of a functional phase; wherein, the organic carrier includes the following materials in parts by weight, specifically: 50%-95% of an organic solvent, 1%-40% of a thickener, 0%-5% of an organic auxiliary; the functional phase includes the following materials in parts by weight, specifically: 40%-95% of a rare earth doped infrared radiation semiconductor material, 5%-60% of a conductor material, 0%-20% of a functional additive. Through the above material ratios, the rare earth doped semiconductor infrared radiation thick-film electronic paste of the present invention has a wide range of selectable base materials, a wide heating temperature range covering medium and low to high temperatures, high heating efficiency, and a heating body of low temperature, and can achieve bidirectional conversion of heat to electricity and electricity to heat.

The present invention has another beneficial effect as follows: a method for preparing a rare earth doped semiconductor infrared radiation thick-film electronic paste includes the following process steps, specifically: a. mixing 50-95% by weight of a thickener, 1-40% by weight of an organic auxiliary and 0-5% by weight of an organic solvent to obtain an organic carrier; b. mixing 10-90% by weight of an organic carrier and 10-90% by weight of a functional phase, and grounding the same to obtain an electronic paste, wherein the functional phase includes the following materials in parts by weight: 40%-95% of rare earth doped infrared radiation semiconductor material, 5%-60% of a conductor material and 0%-20% of a functional additive; c. printing the prepared electronic paste onto a substrate by screen printing, and curing or sintering it to form film to obtain a rare-earth doped semiconductor infrared radiation thick-film. A rare earth doped semiconductor infrared radiation thick-film electronic paste can be effectively prepared by the method for preparing a rare earth doped semiconductor infrared radiation thick-film electronic paste according to the present invention through the above process step designs.

### DETAILED DESCRIPTION

The present invention will be described below with reference to specific embodiments.

### EXAMPLE 1

A rare earth doped semiconductor infrared radiation thick-film electronic paste consisting of two parts: an organic carrier and a functional phase, wherein the weight percentage of organic carrier is 50% and the weight percentage of functional phase is 50%.

When preparing, the following steps were adopted: step 1, a thickener, an organic auxiliary and an organic solvent were mixed according to an ratio of 80 wt % of organic solvent, 15 wt % of thickener and 5 wt %, of organic auxiliary, to obtain an organic carrier; wherein the organic solvent was 50 wt % of terpineol, 10 wt % of tritolyl phosphate isopropanol, 10 wt % of butyl carbitol, 5 wt % of ethanol, 5 wt % of ethyl acetate, 5 wt % of cyclohexanone, 5 wt % of amyl propionate, 5 wt % of diffusion pump oil, 5 wt % of tributyl phosphate; the thickener was 50 wt % of ethyl cellulose, 50 wt % of silicone resin; the organic auxiliary was 30 wt % of a leveling agent, 25 wt % of an anti-foaming agent, 10 wt % of a thixotropic agent, 10 wt % of an adhesion promoter, 5 wt % of a curing agent, 10 wt % of a dispersant and 10 wt % of a toughening agent;
step 2, the organic carrier and a functional phase were mixed, and ground to obtain an electronic paste, wherein the functional phase had the following components: 30 wt % of silver powder, 30 wt % of yttrium and lanthanum doped CuS, 20 wt % of samarium doped TiO2, functional additive 1 wt % of copper oxide;
step 3, the electronic paste was printed onto a polyimide film substrate by screen printing, cured at 200° C. to form a film,

Through the above material ratios, the rare earth doped semiconductor infrared radiation thick-film electronic paste of Example 1 has the following advantages, specifically: 1. compared with the conventional heating materials, the rare earth doped semiconductor infrared radiation electronic paste of Example 1 mainly uses a rare earth doped semiconductor infrared radiation mode for heating, which has high power density, high heating efficiency, good weathering resistance, and the thick film itself has a low temperature; 2. compared with the conventional heating materials, the rare earth doped semiconductor infrared radiation electronic paste of Example 1 has a wide range of selectable base materials, has applications in various fields, and can meet the high-power heating requirements of a flexible thin film; 3. compared with the conventional heating materials, the rare earth doped semiconductor infrared radiation electronic paste of Example 1 can realize a bidirectional function of electro thermal conversion and thereto-electric conversion. After applying the paste, the electrical energy can be converted to thermal energy, and the thermal energy can also be converted to electrical energy when the paste is subject to heat.

### EXAMPLE 2

A rare earth doped semiconductor infrared radiation thick-film electronic paste consisting of two parts: an organic carrier and a functional phase, wherein the weight percentage of organic carrier is 35% and the weight percentage of functional phase is 65%.

When preparing, the following steps were adopted: step 1, a thickener, an organic auxiliary and an organic solvent were mixed according to an ratio of 90 wt % of organic solvent, 5 wt % of thickener and 5 wt % of organic auxiliary, to obtain an organic carrier; wherein the organic solvent was 45 wt % of terpineol, 10 wt % of triphenyl phosphate, 10 wt % of ethyl acetate, 15 wt % of cyclohexanone, 10 wt % of furfuryl alcohol, 5 wt % of diffusion pump oil, 5 wt % of tributyl phosphate; the thickener was 55 wt % of ethyl cellulose, 30 wt % of acrylic resin, 15% of amino resin; the organic auxiliary was 30 wt % of a leveling agent, 25 wt % of a foam suppressor, 15 wt % of a thixotropic agent, 10 wt % of an adhesion promoter, 10 wt % of a dispersant and 10 wt % of an anti-skinning agent;
step 2, the organic carrier and a functional phase were mixed, and. ground to obtain an electronic paste, wherein the functional phase had the following components: 25 wt % of silver/palladium (60/40%), 30 wt % of yttrium doped ZnO, 20 wt % of samarium doped SiC, 15 wt % of dysprosium doped CuS, 5 wt % of neodymium doped AlCaN, functional additive 5 wt % of glass powder;
step 3, the electronic paste was printed onto a stainless steel substrate by screen printing, sintered at 850° C. to form a film.

### EXAMPLE 3

A rare earth doped semiconductor infrared radiation thick-film electronic paste consisting of two parts: an organic carrier and a functional phase, wherein the weight percentage of organic carrier is 25% and the weight percentage of functional phase is 75%.

When preparing, the following steps were adopted: step 1, a thickener, an organic auxiliary and an organic solvent were mixed according to an ratio of 92 wt % of organic solvent, 4 wt % of thickener and 4 wt % of organic auxiliary, to obtain an organic carrier; wherein the organic solvent was 55 wt % of terpineol, 10 wt % of triphenyl phosphate, 10 wt % of turpentine, 10 wt % of butyl carbitol, 5 wt % of furfuryl alcohol, 5 wt % of diffusion pump oil, 5 wt % of tributyl citrate; the thickener was 45 wt % of polyester resin, 40 wt % of phenolic resin, 15 wt % of cellulose acetate butyrate; the organic auxiliary was 30 wt % of an anti-foaming agent, 35 wt % of a wetting agent, 25 wt % of a thixotropic agent, 10 wt % of an adhesion promoter;

step 2, the organic carrier and a functional phase were mixed, and ground to obtain an electronic paste, wherein the functional phase had the following components: 10 wt % of nickel, 10 wt % of Cr, 5 wt % of tungsten, 5 wt % of molybdenum, 25 wt % of yttrium doped Ta2O5, 20 wt % of yttrium doped Cr2O3, 10 wt % of samarium doped SiC, 5 wt % of dysprosium doped TiC, 5 wt % of neodymium doped AlN, the functional additive was 5 wt % of glass powder;

step 3, the electronic paste was printed onto a ceramic substrate by screen printing, sintered at 1350° C. to form a film.

The above contents are merely preferred embodiments of the present invention. Those skilled in the art can make modifications to specific embodiments and application fields according to the concept of the present invention. The content of this specification should not be construed as limiting the present invention.

1. A rare earth doped semiconductor infrared radiation thick-film electronic paste, including the following materials in parts by weight:
10%-90% of an organic carrier
10%-90% of a functional phase;
wherein, the organic carrier includes the following materials in parts by weight:
50%-95% of an organic solvent
1%-40% of a thickener
0%-5% of an organic auxiliary;
the functional phase includes the following materials in parts by weight:
40%-95% of a rare earth doped infrared radiation semiconductor material
5%-60% of a conductor material
0%-20% of a functional additive.

2. The rare earth doped semiconductor infrared radiation thick-film electronic paste according to claim 1, wherein the organic solvent is a combination of two or more of terpineol, methyl ether, turpentine, tritolyl phosphate isopropanol, ethyl ether, xylene, butyl carbitol acetate, benzyl alcohol, butyl carbitol, ethanol, dibutyl phthalate, propanol, diethyl phthalate, triphenyl phosphate, ethyl acetate, amyl propionate, dioctyl phthalate, furfuryl alcohol, tributyl citrate, diffusion pump oil, cyclohexanone, tributyl phosphate, ethyl lactate, and ethyl benzoate.

3. The rare earth doped semiconductor infrared radiation thick-film electronic paste according to claim 2, wherein the thickener is a combination of two or more of ethyl cellulose, cellulose acetate butyrate, acrylic resin, amino resin, polyester resin, phenolic resin, polyimide resin, silicone resin, epoxy resin, and rosin resin.

4. The rare earth doped semiconductor infrared radiation thick-film electronic paste according to claim 3, wherein the organic auxiliary is a combination of two or more of a leveling agent, an anti-foaming agent, a thixotropic agent, an adhesion promoter, a curing agent, a dispersant, a wetting agent, a toughening agent, an emulsifier, an anti-skinning agent, a delusterant, a light stabilizer, an anti-mould agent, an anti-static agent, an anti-adhesion agent, an anti-cratering agent, a hammer tone auxiliary, a foam suppressor, an anti-gelling agent, and an anti-floating agent.

5. The rare earth doped semiconductor infrared radiation thick-film electronic paste according to claim 4, wherein the rare earth doped infrared radiation semiconductor material is one of rare earth doped TiO2, TiC, SiC, AlN, SnO2, CdO, Fe2O3, Cr2O3, Al2O3, AlCaN, GaN, InAlN, Cu2O, NiO, VO2, Ta2O5, WC, TaC, VC, ZrC, HfC, CdO, MnO2, CoO, Cu2O, CoO, Cr2O3, SnO, Cu2S, SnS, Hg2O, PbO, Ag2O, Ag2O, Cr2O3, MnO, CoO, SnO, NiO, Cu2O, Cu2S, Pr2O3, SnS, Sb2S3, CuI, Bi2Te3, Te, Se, MoO2, Hg2O, V2O5, CrO3, ZnO, WO3, CuO, MoO2, Ag2S, CdS, Nb2O5, BaO, ZnF2, Hg2S, Fe3O4, V2O5, V3O8, Ag2S, Nb2O5, MoO3, CdO, CsS, CdS, CdSe, SnO2, WO3, Cs2Se, BaO, Ta2O5, BaTiO3, PbCrO4, Fe3O4, Hg2S, ZnF2, ZnO, CdCr2Se4, and LaFeO3, or a combination of two or more thereof.

6. The rare earth doped semiconductor infrared radiation thick-film electronic paste according to claim 5, wherein the conductor material is one of a metal conductor material, an inorganic non-metal conductor material, and a polymer conductor material, or a combination of two or more thereof; the state of conductor material is one of powder, fiber and solution, or a combination of two or more thereof; the metal conductor material is one of aluminum, copper, chromium, molybdenum, vanadium, zinc, nickel, cobalt, tungsten, manganese, gold, silver, platinum, ruthenium, rhodium, palladium, osmium, iridium and metal alloy, or a combination of two or more thereof; the inorganic non-metal conductor material is one of a carbon material, a conductive glass and a metal oxide, or a combination of two or more thereof; the polymer conductor material is one of polyacetylene, polythiophene, polypyrrole, polyaniline, polyphenylene, polyphenylenevinylene and polydiacetylene, or a combination of two or more thereof.

7. The rare earth doped semiconductor infrared radiation thick-film electronic paste according to claim 6, wherein the carbon material is one of graphene, electric conductive carbon black, chopped carbon fiber, carbon nanofiber, carbon nanotube, spiral carbon and graphite powder, or a combination of two or more thereof.

8. The rare earth doped semiconductor infrared radiation thick-film electronic paste according to claim 7, wherein the rare earth is one of a rare earth elementary substance and a rare earth compound, or a combination of two or more thereof; the rare earth elementary substance is one of scandium, yttrium, lanthanum, cerium, praseodymium, neodymium, promethium, samarium, europium, gadolinium, terbium, dysprosium, holmium, erbium, thulium, ytterbium, lutetium, and scandium, or a combination of two or more thereof; the rare earth compound is one of oxides and salts of scandium, yttrium, lanthanum, cerium, praseodymium, neodymium, promethium, samarium, europium, gadolinium, terbium, dysprosium, holmium, erbium, thulium, ytterbium, lutetium, and scandium, or a combination of two or more thereof.

9. The rare earth doped semiconductor infrared radiation thick film electronic paste according to claim 8, wherein the functional additive is one of an inorganic binder, an electrical performance enhancer, a reinforcing agent, a toughening agent, and a fluxing agent, or a combination of two or more thereof; the inorganic binder is one of a glass powder, an oxide of copper and another compound of copper, or a combination of two or more thereof; the electrical performance enhancer is one of a metal compound, an intermetallic compound and a ceramic powder, or a combination of two or more thereof.

10. A method fir preparing a rare earth doped semiconductor infrared radiation thick-film electronic paste, including the following process steps:
a. mixing a thickener, an organic auxiliary and an organic solvent to obtain an organic carrier, wherein the parts by weight of the thickener, the organic auxiliary and the organic solvent are 50-95%, 1-40% and 0-5%, respectively.
b. mixing the organic carrier and a functional phase, and grounding the same to obtain an electronic paste, wherein the parts by weight of the organic carrier and the functional phase are 10-0% and 10-90%, respectively, and the functional phase includes the following materials in parts by weight: 40%-95% of a rare earth doped infrared radiation semiconductor material, 5%-60% of a conductor material, and 0%-20% of a functional additive;
c. printing the prepared electronic paste onto a substrate by screen printing, and curing or sintering it to form a film to obtain a rare earth doped semiconductor infrared radiation thick-film.
